(19) United States
(12) Patent Application Publication
(10) Pub. No.: US 2019/0180960 A1
(43) Pub. Date: Jun. 13, 2019

(54) INDEXED ROTARY SWITCH

(71) Applicant: BCS AUTOMOTIVE INTERFACE SOLUTION GMBH, Radolfzell (DE)

(72) Inventor: MARKUS ALTMANN, MOOS-BANKHOLZEN (DE)

(21) Appl. No.: 16/327,133

(22) PCT Filed: Aug. 18, 2017
(86) PCT No.: PCT/EP2017/070944

§ 371 Date: Feb. 21, 2019

(30) Foreign Application Priority Data
Aug. 22, 2016 (DE) 10 2016 115 548.9

(51) Int. Cl. H01H 25/06

(52) U.S. Cl. CPC H01H 25/06; H01H 19/11

(57) ABSTRACT

An indexed rotary switch (10), in particular a rotary pushbutton switch in a vehicle, includes a base body (12) and a spring ring (26) which is locked to the base body (12) so as to prevent rotation.

### RELATED APPLICATIONS

This application corresponds to PCT/EP2017/070944, filed Aug. 18, 2017, which claims the benefit of German Application No. 10 2016 115 548.9, filed Aug. 22, 2016, the subject matter of which are incorporated herein by reference in their entirety.

The invention relates to an indexed rotary switch, in particular a rotary pushbutton switch in a vehicle.

Indexed rotary switches include a latching cam for a spring-mounted projection to engage therein. The increment of the indexing is predefined by the distance of the individual latching contours of the latching cam, between which the projection can engage. The projection is part of a spring ring, for example, which is arranged between the rotary member of the rotary switch and a base body and urges the rotary member away from the base body, the projection being urged against the latching cam. The spring force, on the one hand, causes the projection to be urged into the latching cam or between the latching contours. On the other hand, the entire rotary member is urged away from the base body and is thus held free of play. By way of supplement, a pushbutton switch may additionally be integrated by moving the rotary member against an electrical contact contrary to the spring force of the spring ring, DE 10 2014 106 568 A1 shows a typical rotary switch of this type.

In rotary switches of this type it is necessary for the spring ring to be securely fixed in place in order to ensure precise control and thus the desired high level of operating comfort. Various methods for securely fastening spring rings in rotary switches are known from the prior art. For one thing, additional fastening means such as screws or bolts are made use of for fixing the spring ring in place. For another thing, use is made of plastic pins that extend through the spring ring and are deformed at a high temperature so that the spring ring is secured with an interlocking fit. However, these methods have the drawback that they require additional components or systems in manufacture and therefore involve higher cost and effort.

### SUMMARY OF THE INVENTION

It is therefore the object of the invention to provide a rotary switch having a more cost-efficient fastening for a spring ring.

To achieve the object, provision is made for an indexed rotary switch, in particular a rotary pushbutton switch in a vehicle, including a base body and a spring ring, the spring ring being locked to the base body so as to prevent rotation. The spring ring and/or the base body include(s) latching elements here which can latch to each other and in this way ensure a rotationally fixed and secure fastening of the spring ring, in particular in the axial direction, without this requiring any additional fastening means or special tools. The spring ring may have a shape deviating from that of a ring; in particular, half a spring ring also is a spring ring within the meaning of the invention.

According to an advantageous embodiment, the spring ring includes two holding sections located radially opposite each other. Further, two fastening sections which each have a supporting surface are provided on the base body, the spring ring resting by the holding sections against the fastening sections in the axial direction. By having the spring ring including two holding sections radially opposite each other, the spring ring is mounted on the base body with greater stability. The contact in the axial direction ensures that the axial forces which occur upon actuation of the rotary switch can be better transmitted from the spring ring to the base body and can be better absorbed by the rotary switch.

Each fastening section may have a recess which interrupts the supporting surface at least in sections. This recess thus forms a gap between the holding section of the spring element and the fastening section of the base body, allowing the spring element to be pressed into this recess at least in sections. This overpressing of the holding sections can be utilized when fastening the spring element, in order to ensure that the spring element is securely latched to the base body.

Preferably, the recess comprises at least 50%, in particular 100%, of the width of the supporting surface in the radial direction. This has the advantage that the gap extends under the holding section as far as possible in the radial direction, to allow the latter to be overpressed in as large a radial region as possible.

The recess in the circumferential direction preferably has a length which comprises at least 25%, preferably at least 50%, more preferably at least 75% of the length in the circumferential direction of the holding sections. This design is advantageous since in this way the gap in the circumferential direction accounts for as large a region as possible under the holding section, allowing the holding section to be overpressed more easily.

It is of advantage if the recess has a depth in the axial direction of less than 1 mm, preferably less than 0.5 mm, more preferably of 0.1 mm. In this way, the recess is sufficiently deep to ensure that the latching elements snap securely into place, but at the same time only so deep that the spring ring will not be damaged by the deformation during overpressing. In addition, in these cases the bottom of the recess may serve as a stop, by means of which the process reliability can be increased, in particular in the case of manual fastening of the spring ring.

In a preferred embodiment, the holding sections have holding tabs provided thereon for mounting the spring ring so as to prevent rotation. Due to their design, holding tabs offer additional fastening possibilities and are therefore suitable for ensuring that the spring ring is fixed in the axial and circumferential directions.

In a further preferred embodiment, each holding section has two holding tabs provided thereon that are opposite each other and form a U-profile together with the holding section. This design improves the stability of the spring ring and defines the radial position of the spring ring.

Each holding section preferably includes a holding tab having a latching tongue and each fastening section includes a respective undercut in which the latching tongue can latch in the axial direction. In this way, the spring element can be simply and securely fastened in the axial direction without any additional fastening means, such as screws or bolts, being required therefor.

It is advantageous if at least some of the holding tabs have latching lugs which can each latch with a fastening section. This provides additional fastening means which can be intended to secure the fastening of the spring ring to the base body.

Preferably, each fastening section comprises a groove in which a holding tab can be received so as to prevent rotation. In this way the stability of the fastened spring ring is increased, in particular in that torques can be absorbed which otherwise caused the spring ring to tilt or turn.

In an advantageous embodiment, each holding section includes a holding tab having one, in particular two oppositely arranged tab sections, the tab sections projecting from the holding tabs in or against the circumferential direction and resting against the corresponding fastening sections on preferably angled circumferential surfaces in the radial direction. The tab sections increase the contact surface by which the holding tabs rest against the base body, and thereby improve the stability of the spring ring. By the circumferential surfaces of the fastening sections being angled in the regions opposite the tab sections in relation to those regions in which the holding tabs do not have a tab section, the spring ring is fixed in place in or against the circumferential direction.

The rotary switch may comprise a rotary member which is rotatable about a longitudinal axis and is mounted on the base body for limited displacement in the direction of the longitudinal axis, a latching cam having latching contours being provided on the base body and/or on the rotary member. Further, the spring ring may include an indexing section having a resiliently yielding projection which can engage in the latching cam. This design provides the functionalities of the indexed rotary pushbutton switch in an efficient manner, namely the adjusting of the rotary member in the axial direction to at least two positions and the rotating of the rotary member about the longitudinal axis to a plurality of positions as predefined by the latching cam.

Preferably, the spring ring is pretensioned against the latching cam such that the at least one projection of the indexing section engages between two neighboring latching contours. The projection in the indexing section is thereby securely mounted between two latching contours, allowing the rotary switch to be adjusted to clearly defined positions.

To prevent the spring ring from rotating along with the latching cam, holding tabs are preferably provided on the spring ring for mounting the spring ring so as to prevent rotation, the holding tabs more particularly projecting in the opposite direction than the contact surface and the projection.

According to a further preferred embodiment, the spring ring comprises at least one contact section which includes a contact surface that can rest on the latching cam, the radius of curvature of the contact surface being considerably larger than the radius of curvature of the projection, and the contact section being pretensioned against the latching cam such that the contact section rests by the contact surface on at least two neighboring latching contours of the latching cam and acts on the rotary member in the axial direction. In this way, in addition to the indexing section, by which the indexing of the rotary switch is provided in the known manner, the rotary switch comprises a contact section which rests at the cam but cannot engage into it. This means that the contact surface of the contact section is springily pressed against the latching cam, so that an increased friction is produced between the latching cam and the contact surface, the friction providing a resistance when the rotary member is rotated. This resistance, which is provided additionally, may be made use of for increasing the operating comfort.

When the rotary switch is rotated, the indexing section, which is arranged on one side of the spring ring, is periodically deflected by the latching contours, whereby the spring ring is deformed and tensions are produced in the spring ring. In order that these tensions do not affect the contact section which is arranged in particular on the opposite side of the indexing section, it is particularly important that the spring ring is securely fastened to the holding sections which are arranged in particular between the indexing section and the contact section. The fastening of the rotary switch according to the invention ensures that the contact section is decoupled from the indexing section and rests against the latching cam with an essentially constant pretensioning farce. In this way, a defined frictional resistance can be provided at the rotary member, although the spring ring is variably deformed at the indexing section upon rotation.

### BRIEF DESCRIPTION OF THE DRAWINGS

Further advantages and features will be apparent from the description below in conjunction with the accompanying drawings, in which:

FIG. 1 shows a perspective view of a rotary switch from the prior art;

FIG. 2 shows a perspective view of the spring ring of the rotary switch of FIG. 1;

FIG. 3 shows a perspective view of a rotary switch according to the invention;

FIG. 4 shows a perspective view of the spring ring of the rotary switch of FIG. 3;

FIG. 5 shows a schematic sectional view of the mounting of the spring ring in the rotary switch of FIG. 3;

FIG. 6 shows a schematic sectional view of the mounting of the spring ring in a further embodiment of the rotary switch according to the invention;

FIG. 7 shows a schematic sectional view of the mounting of the spring ring in the rotary switch of FIG. 6;

FIG. 8 shows a perspective view of a further embodiment of a spring ring for a rotary switch according to the invention;

FIG. 9 shows a schematic sectional view of the mounting of the spring ring of FIG. 8 in a rotary switch according to the invention; and

FIG. 10 shows a schematic side view of the mounting of the spring ring of FIG. 8 in a rotary switch according to the invention.

### DETAILED DESCRIPTION

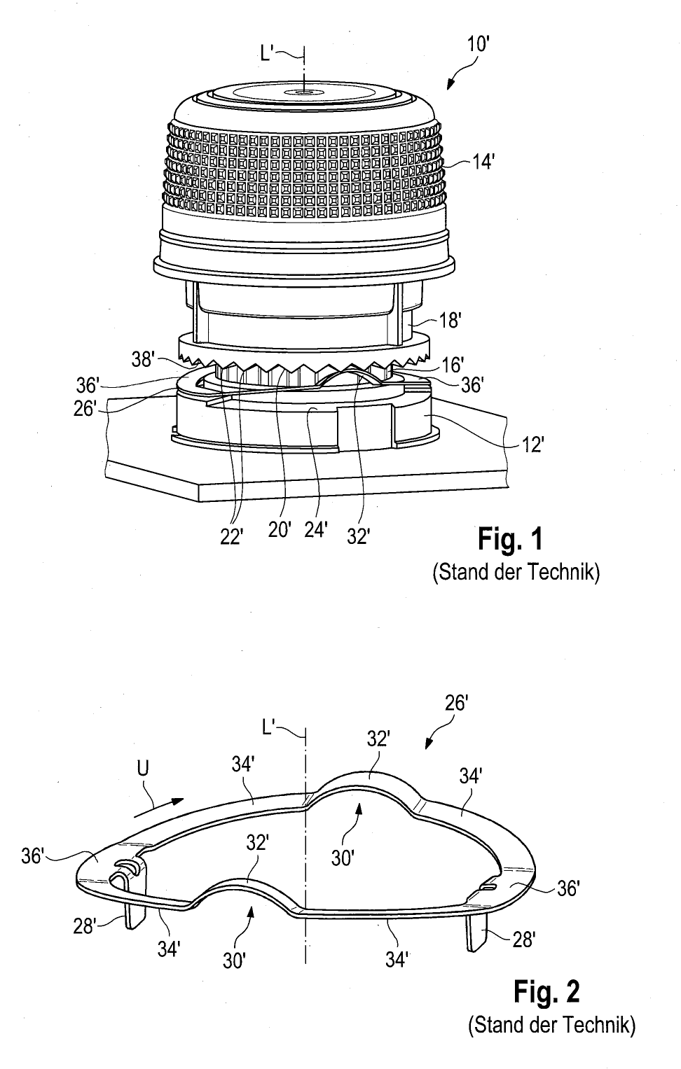

FIG. 1 shows a rotary switch 10′ from the prior art. The rotary switch 10′ has a base body 12′ which has a rotary member 14′ mounted thereon for rotation about a longitudinal axis L′ and for limited displacement in the direction of the longitudinal axis L′. The base body 12′ includes a protruding dome 16′ which extends into the interior of the rotary member 14′.

Provided on the lower front face, with respect to FIG. 1, of the rotary member 14′ is an indexing member 18′ which includes a latching cam 20′ protruding contrary to the longitudinal direction L′ and having a plurality of latching contours 22′, Further provided on the base body 12′ is a shoulder 24′ on which the spring ring 26′ rests which is shown in FIG. 2.

The spring ring 26′ is stamped out of a metal sheet and has a pair of protruding holding tabs 28′ bent at right angles contrary to the longitudinal direction L′ and engaging into slots on the shoulder 24′ so that the spring ring 26′ is mounted on the base body 12′ so as to prevent rotation in the circumferential direction U. The spring ring 26′ further includes a pair of indexing sections 30′ which each have a projection 32′ and spring sections 34′ that are arranged in front of and behind the projections 32′ in the circumferential direction U.

As can be seen in FIG. 1, the spring ring 26′ rests on the shoulder 24′ by a pair of holding sections 36′ which are located opposite each other in the circumferential direction and have the holding tabs 28′ provided thereon, and is held by the holding tabs 28′ so as to prevent rotation about the longitudinal axis L′ with respect to a direction of rotation.

The rotary member 14′ is placed with its latching cam 20′ on the base body 12′ such that the indexing sections 30′ are pretensioned in the longitudinal direction L′ between the shoulder 24′, that is, the base body 12′ and the latching cam 20′ of the rotary member 14′. This causes the projections 32′ to be urged against the latching cam 20′ or the latching contours 22′ and between the latching contours 22′.

Rotation of the rotary member 14′ is only possible when the projections 32′ are urged back by the latching contour 22′ contrary to the longitudinal direction L′. The projections subsequently snap into the next recess 38′ between the latching contours 22′.

Instead of a spring ring 26′ having two indexing sections 30′, spring rings 26′ are also known from the prior art in which one of the two indexing sections 30′ is replaced by a contact section having a contact surface.

In contrast to the projection 32′, the contact surface has a considerably smaller curvature, as a result of which it cannot engage between the latching contours 22′, but can only rest on the latching cam 20′, that is, the latching contours 22′.

Thus, while the spring sections 34′ provide a spring force in the longitudinal direction L′, no additional force is provided for indexing the rotary member 14′ since the contact surface cannot engage between the latching contours 22′.

The contact surface therefore generally increases the frictional resistance in the direction of rotation of the rotary member 14′ without changing the characteristic of the indexing by the projection 32′ and the latching cam 20′.

A spring ring 26′ having an indexing section and a contact section thus has a dual function: For one thing, the spring ring provides for the indexing of the rotary switch 10′ or of the rotary member 14′. For another thing, the spring ring 26′ generally increases the friction between the rotary member 14′ and the base body 12′ or provides a spring force in the longitudinal direction L′, which, firstly, allows the haptics of the rotary switch 10′ to be adjusted and, secondly, allows the rotary member 14′ to be mounted free of play, without a change in the characteristic of the indexing.

In addition, the rotary switch 10′ may have a push function, so that an electrical contact is established by pushing in the rotary member 14′ contrary to the longitudinal direction L.

The resistance to a pressing in of the rotary member 14′ may be increased, for example by increasing the spring tension of the spring sections 34′.

In this embodiment, the spring ring 26′ is fastened in slots on the shoulder 24′ merely by means of the holding tabs 28′. To be able to mount the delicate spring ring 26′ manually without bending it, the holding tab 28′ is dimensioned with clearance with respect to its seat. This will promote assembly errors. Even with correct assembly, however, there is no defined, fixed position relative to the latching cam 20′.

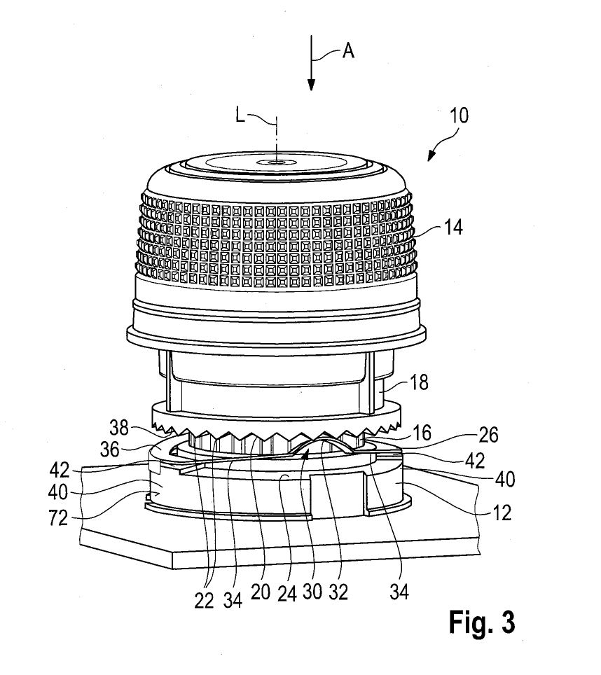

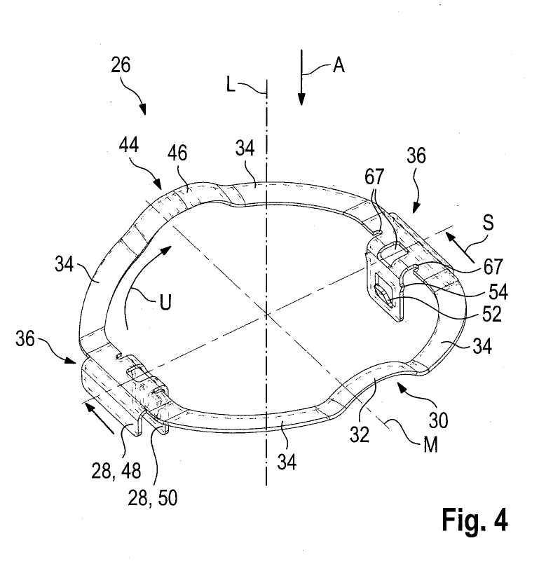

To overcome these problems, the rotary switch 10 according to the invention shown in FIG. 3 having the spring ring 26 shown in FIG. 4 is provided. The rotary switch 10 essentially corresponds to the rotary switch 10′ shown in FIG. 1 and includes at its shoulder 24′ two fastening sections 40, each having a supporting surface 42, against which the spring ring 26 rests by its holding sections 36 in the axial direction A. The spring ring 26 shown in FIG. 4 essentially corresponds to the spring ring 26′ shown in FIG. 2 and, instead of a second indexing section 30′, it may comprise the contact section already mentioned above (provided with reference number 44 here). The considerably smaller curvature in comparison to the projection 32 can be clearly seen.

This spring ring 26 is also stamped out of a metal sheet and is constructed to be symmetrical with respect to the axis M. The spring ring 26 further includes two holding sections 36 located opposite each other in the circumferential direction U and each offset by about 90° from the indexing section 30 or the contact section 44 in the circumferential direction U.

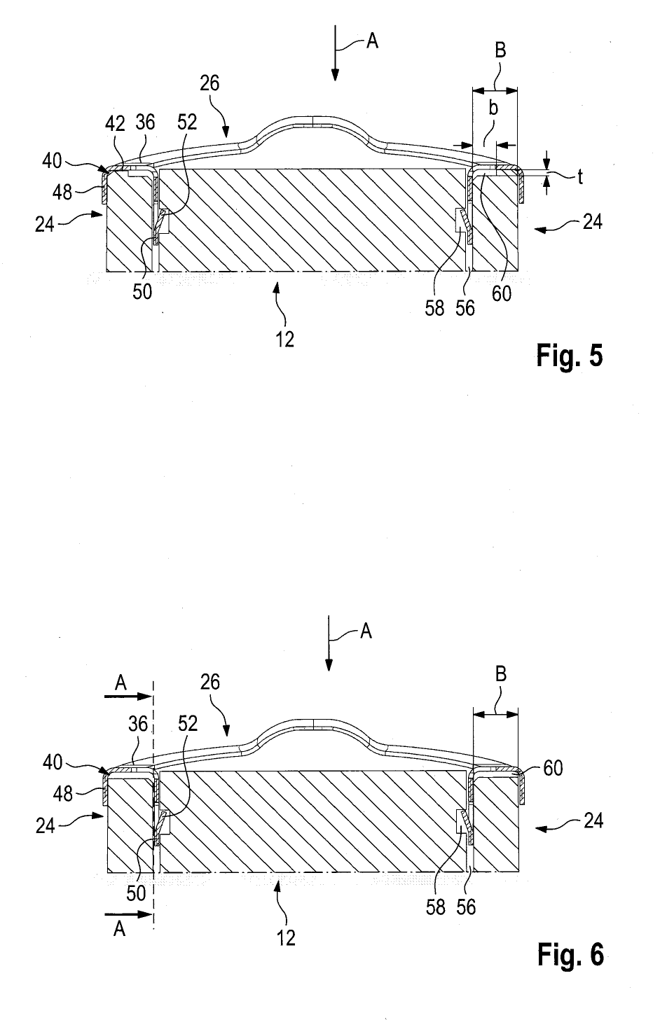

Each holding section 36 comprises a pair of holding tabs 28, an outer holding tab 48 arranged radially on the outside of the spring ring 26, and an inner holding tab 50 arranged radially on the inside of the spring ring 26. The outer and inner holding tabs 48, 50 of each holding section 36 are bent at right angles and protrude in the axial direction A, so that they form a U-profile with the respective holding section 36 (see FIGS. 5 and 6).

In comparison to the outer holding tab 48, the inner holding tab 50 protrudes further in the axial direction A and includes a latching tongue 52 and two latching lugs 54.

The latching tongue 52 is formed by a section arranged centrally in the inner holding tab 50 and deflected radially inwards and counter to the axial direction A.

The latching lugs 54 project from the inner holding tab 50 oppositely to each other and in and counter to the circumferential direction U, respectively.

FIG. 5 shows a sectional view taken through the sectional axis S (see FIG. 4) of the spring ring 26 in its state installed in the rotary switch 10, with the base body 12 of the rotary switch 10 being illustrated cut off at the level of the spring ring 26 for greater clarity.

The base body 12 has a groove 56 at each fastening section 40 for receiving the inner holding tab 50 and, adjacent to the groove 56, an undercut 58 in which the latching tongue 52 of the inner holding tab 50 can latch counter to the axial direction A.

The spring ring 26 rests against the supporting surfaces 42 of the fastening sections 40 in the axial direction A. The fastening sections 40 each have a recess 60 under the holding section 36 in the axial direction A, so that at these points the supporting surfaces 42, against which the spring ring 26 rests, are interrupted.

The depth T of the recess 60 in the axial direction A may range from 0.1 mm to 1 mm.

In an alternative embodiment, the depth T of the recess 60 in the axial direction A may be more than 1 mm, in particular 2 mm to 5 mm.

The width b of the recess 60 in the radial direction amounts to about half the width B of the supporting surface 42 in the radial direction.

As in the embodiment shown in FIG. 6, the recess 60 may also extend over the entire width B.

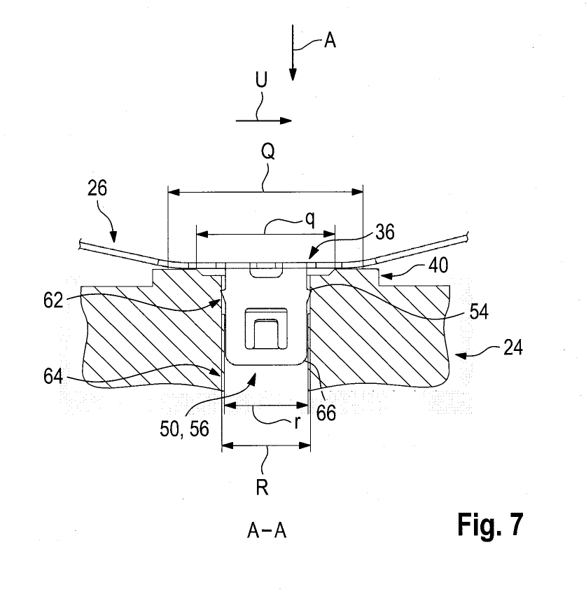

FIG. 7 shows the holding section 36, resting against the supporting surface 42, from FIG. 6 in a side view. The recess 60 interrupts the supporting surface 42 in the circumferential direction U, so that the holding section 36 rests against the fastening section 40 at two sections of the supporting surface 42 separate from each other.

The length g of the recess 60 in the circumferential direction U may be between 25% and 75% of the total length Q in the circumferential direction U of the holding section 36.

The fastening section 40 protrudes from the shoulder 24 counter to the axial direction A.

The groove 56 comprises a first section 62 adjacent to the holding section 36 and a second section 64 adjoining the first section 62 in the axial direction.

The second section 64 has a width r in the circumferential direction U. The width r substantially corresponds to the width of the inner holding tab 50, so that the latter is accommodated in the groove 56 in the circumferential direction U by means of an interlocking fit.

The first section 62 has a larger width R as compared with the width r of the second section 64, as a result of which the groove 56 is configured to latch with the latching lugs 54 protruding from the inner holding tab 50 in the circumferential direction U.

The inner holding tab 50 has rounded portions 66 at its end projecting from the spring ring 26 in the axial direction U in order to prevent the holding tab 50 from getting caught with the groove 56 during insertion and thus to facilitate insertion.

When mounting the spring ring 26, the spring ring 26 is inserted into the base body 12 so that the inner holding tabs 50 protrude into the corresponding grooves 56 of the fastening sections 40 and the holding section 36 abuts against the supporting surfaces 42 in the axial direction A. The holding sections 36 are then pressed into the recesses 60 beyond their contact position. During this overpressing, the spring ring 26 is elastically deformed and springs back again when the pressure decreases, so that the latching tongues 52 snap into the corresponding undercuts 58 and the spring ring 26 is mounted free of play.

The holding sections 36 have notches 67 (see FIG. 4) on the radial inner side, i.e. on the side on which the inner holding tabs 50 are arranged, the notches 67 improving the flexibility of the holding sections 36 in the region of the inner holding tabs 50 and thus facilitating the latching of the spring ring 26 by overpressing.

The overpressing of the spring rings 26 can be effected in the course of manufacture by means of a hand lever press (not shown).

In a further embodiment, the recesses 60 may be configured to be very shallow and have a depth t of up to 0 mm, i.e. embodiments of the rotary switch 10 according to the invention that have no recesses 60 are also possible. Here the supporting surfaces 42 or the fastening sections 40 are elastically deformed during assembly by the pressure on the holding sections 36, so that the latching tongues 52 latch into the corresponding undercuts 58 and the spring ring 26 is mounted free of play.

The overpressing causes the spring ring 26 to be firmly connected to the base body 12 in the axial direction A, in particular under pretension. Since the inner holding tabs 50 are received with a form fit in the second section 64 of the groove 56 in the circumferential direction U, the spring ring 26 is additionally mounted such that rotation is prevented. The inner and outer holding tabs 48, 50, configured as a U-profile with the holding section 36, further ensure a secure fastening in the radial direction. In this way, the spring ring 26 can be fastened to the base body 12 free of play and process-reliably without additional fastening means.

Due to the fact that the width of the groove 56 in the radial direction is roughly the same as the thickness of the inner holding tab 50 (see FIG. 5), the latching tongues 52 in the respective undercuts 58 are prevented from being disengaged. As a result, the spring ring 26 further cannot be removed without a deformation of the base body 12 and/or of the spring ring 26.

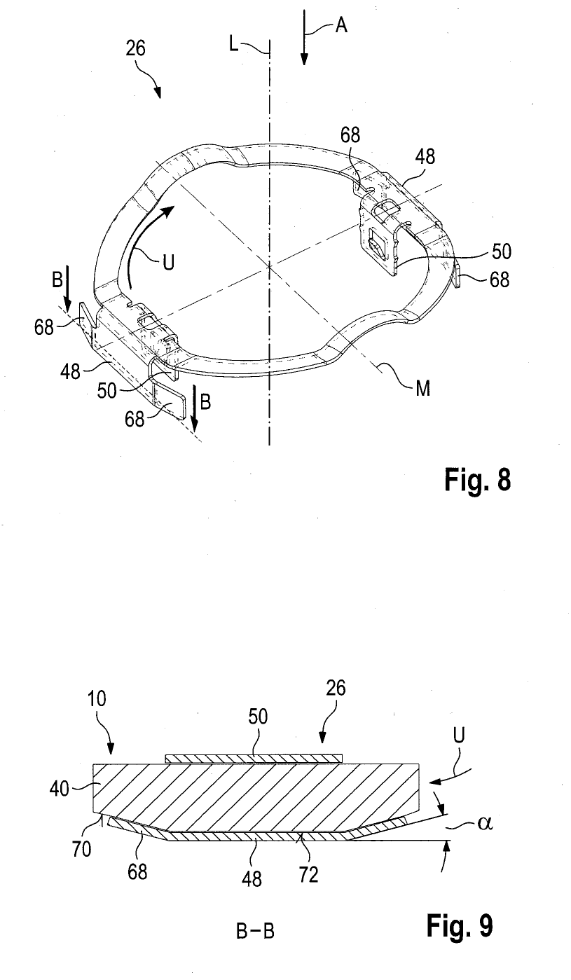

The spring ring 26 shown in FIG. 8 substantially corresponds to the spring ring 26 shown in FIG. 4, but has additional tab sections 68 on the outer holding tabs 48. Each outer holding tab 48 has two oppositely arranged tab sections 68 provided thereon, which project from the outer holding tab 48 in or counter to the circumferential direction U, respectively.

The tab sections 68 are formed in one piece with the outer holding tabs 48.

The tab sections 68 are angled from the outer holding tab 48 in the radial direction toward the longitudinal axis L at an angle α (see FIG. 9).

FIG. 9 shows a section perpendicular to the longitudinal axis L taken through a fastening section 40 of a rotary switch 10 according to the invention, against which the spring ring 26 from FIG. 8 rests.

The fastening section 40 has circumferential surfaces 70 on its radial outer surface 72 (see also FIG. 3), which are angled in relation to the outer surface 72 and located opposite the tab sections 68.

The outer holding tab 48 rests against the outer surface 72, while the tab sections 68 rest against the circumferential surfaces 70.

By the tab sections 68 being arranged on the outer holding tab 48 opposite to each other and resting against the angled circumferential surfaces 70, the spring ring 26 is fixed in place both in and counter to the circumferential direction U.

The outer holding tab 48 having the tab sections 68 can rest against the shoulder 40 with the inner holding tab 50 under pretension so that a press fit is formed. For an easier placement of the spring ring 26, the shoulder 40 may have appropriate chamfers on the axial edges.

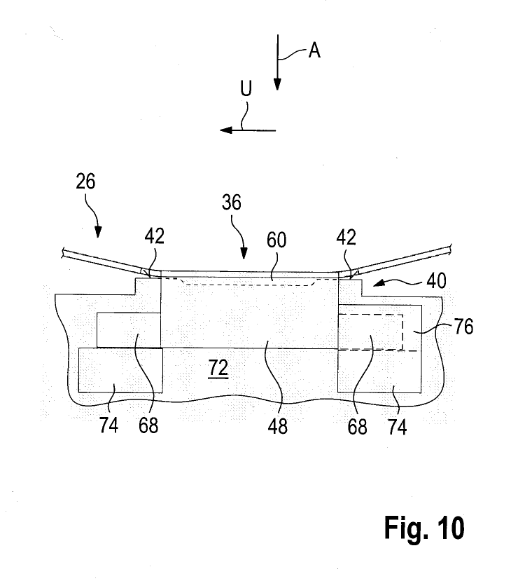

Further, the outer holding tab 48 may rest by the tab sections 68 in the axial direction A against one or more second shoulders 74 provided on the fastening section 40 or on the base body 12 (see FIG. 10), which protrude from the outer surface 72 in the radial direction.

As is shown in FIG. 10, the second shoulders 74 are configured such that only the tab sections 68 rest on the second shoulders 74, while the portion between the tab sections 68 that is formed by the holding tab 48 does not rest on or against the second shoulders 74.

When the spring ring 26 is mounted, the second shoulders 74 support the tab sections 68 against the force applied to the holding section 36 in the axial direction A and thus facilitate the elastic pushing-in of the holding section 36 into the recess 60 beyond its contact position at the supporting surfaces 42. Furthermore, the position of the spring ring 26 is additionally stabilized, in particular by the contact surface, which is wider in the circumferential direction U, and thus the risk of the spring ring 26 being tilted or twisted is further reduced.

In a further embodiment, the second shoulders 74 may include an additional axial section 76, with which the second shoulders 74 form an L-profile in the circumferential direction U.

The additional axial section 76 borders the tab sections 68 in the radial direction and in this way increases the stability of the spring ring 26.

1. An indexed rotary switch (10), in particular a rotary pushbutton switch in a vehicle, comprising a base body (12) and a spring ring (26), wherein the spring ring (26) is locked to the base body (12) so as to prevent rotation.

2. The indexed rotary switch according to claim 1, wherein the spring ring (26) includes two holding sections (36) radially opposite each other and in that two fastening sections (40) each having a supporting surface (42) are provided on the base body (12), the spring ring (26) resting by the holding sections (36) against the fastening sections (40) in the axial direction (A).

3. The indexed rotary switch according to claim 2, wherein each fastening section (40) has a recess (60) which interrupts the supporting surface (42) at least in sections.

4. The indexed rotary switch according to claim 3, wherein the recess (60) comprises at least 50%, in particular 100%, of the width (B) of the supporting surface (42) in the radial direction.

5. The indexed rotary switch according to claim 2, wherein in the circumferential direction (U), the recess (60) has a length (q) which comprises at least 25%, preferably at least 50%, more preferably at least 75% of the length (Q) in the circumferential direction (U) of the holding sections (36).

6. The indexed rotary switch according to claim 3, wherein the recess (60) has a depth (t) in the axial direction (A) of less than 1 mm, preferably less than 0.5 mm, more preferably of 0.1 mm.

7. The indexed rotary switch according to claim 2, wherein the holding sections (36) have holding tabs (28) provided thereon for mounting the spring ring (26) so as to prevent rotation.

8. The indexed rotary switch according to claim 2, wherein each holding section (36) has two holding tabs (28) provided thereon that are opposite each other and form a U-profile together with the holding section (36).

9. The indexed rotary switch according to claim 2, wherein each holding section (36) includes a holding tab (28) having a latching tongue (52) and each fastening section (40) includes a respective undercut (58) in which the latching tongue (52) can latch in the axial direction (A).

10. The indexed rotary switch according to claim 7, wherein at least some of the holding tabs (28) have latching lugs (54) which can each latch with a fastening section (40).

11. The indexed rotary switch according to claim 2, wherein each fastening section (40) comprises a groove (56) in which a holding tab (28) can be received so as to prevent rotation.

12. The indexed rotary switch according to claim 2, wherein each holding section (36) includes a holding tab (28) having one, in particular two oppositely arranged tab sections (68), the tab sections (68) projecting from the holding tabs (28) in or against the circumferential direction (U) and resting against the corresponding fastening sections (40) on preferably angled circumferential surfaces (70) in the radial direction.
